(19) United States
(12) Patent Application Publication
(10) Pub. No.: US 2025/0100424 A1
(43) Pub. Date: Mar. 27, 2025

(54) LATCH ASSEMBLY WITH MULTIPLE CAM SUPPORT SURFACES

(71) Applicant: MAGNA SEATING INC., Aurora (CA)

(72) Inventors: Creston A. Zang, Northville, MI (US); Kristof M. KURZEJA, Commerce Township, MI (US); Detjon MARINI, White Lake, MI (US); Tara TEPIN, Cedar Springs, MI (US)

(21) Appl. No.: 18/727,249

(22) PCT Filed: Jan. 6, 2023
(86) PCT No.: PCT/US2023/010302

§ 371 Date: Jul. 8, 2024

Related U.S. Application Data
(60) Provisional application No. 63/297,045, filed on Jan. 6, 2022.

(51) Int. Cl. B60N 2/015

(52) U.S. Cl. CPC B60N 2/01583

(57) ABSTRACT

A latch assembly for releasably securing a seat assembly to a striker in an automotive vehicle. The latch assembly comprises a housing bracket, a latch link, a cinch cam and a strength cam. The latch link is pivotally coupled to the housing bracket about a first axis of rotation. The cinch cam and a strength cam are pivotally coupled to the housing bracket about a second axis of rotation. The strength cam has first, second and third cam surfaces and the cinch cam has a cinch surface. The latch link has first, second and third latch surfaces spaced between the first and second axes of rotation and a latch groove oriented away from the first and second axes of rotation. The latch link is rotatable between a latched condition engaged with the striker and an unlatched condition disengaged with the striker. The cinch surface in engaged with the first latch surface in the latched condition and the first and second cam surfaces engage with the first and second latch surfaces, respectively, when the latch link is in the latched condition and deformed under load to prevent inadvertent release of the latch assembly from the latched condition to the unlatched condition. The third cam surface engages with the third latch surface to retain the latch link in the unlatched, hold open, position.

### CROSS-REFERENCE TO RELATED APPLICATIONS

This application claims priority to and all the benefits of U.S. Provisional Application 63/297,045, filed on Jan. 6, 2022, and entitled “Latch Assembly with Multiple Cam Support Surfaces,” the disclosure of which is hereby incorporated by reference in its entirety.

### BACKGROUND OF THE INVENTION

### 1. Field of the Invention

The present invention relates to a latch assembly for use with a seat assembly in an automotive vehicle. More particularly, the invention relates to a latch assembly with multiple cam support surfaces to operatively secure a portion of the seat assembly to a striker within the vehicle.

### 2. Description of Related Art

Automotive vehicles typically include one or more seat assemblies having a seat cushion and a seat back for supporting a passenger above a vehicle floor. Certain known vehicles have one or more rows of seat assemblies. Typical seat assemblies generally have an upright in-use position and an optional pitched forward position allowing easy access behind the seat assembly to the interior of the vehicle. The pitched forward position, also described as an easy entry position, allows occupant ingress to and egress from rear rows of vehicle seats.

These seat assemblies typically include a pair of latch assemblies proximate a rear portion of the seat cushion and a pair of pivot brackets proximate the front of the seat cushion for providing pivotal movement of the seat assembly between the use position and the easy entry position. The latch assemblies releasably engage with a pair of strikers mounted on the vehicle floor or fore/aft adjusters for securing the seat assembly in the use position. Once the latch assemblies are released, the seat assembly pivots forwardly to the easy entry position by an applied force supplied by a spring load to provide easy access behind the seat assembly on the inside of the vehicle.

It is desirable to provide an improved latch assembly with increased strength and reduced operational efforts to secure the seat assembly to the strikers between the use and easy entry positions.

### SUMMARY OF THE INVENTION

A latch assembly is provided for releasably securing a seat assembly to a striker in an automotive vehicle. The latch assembly comprises a housing bracket and a latch link pivotally coupled to the housing bracket about a first axis of rotation. A cinch cam and a strength cam are pivotally coupled to the housing bracket about a second axis of rotation spaced apart from the first axis of rotation. The strength cam has first and second cam surfaces spaced apart along an outer edge and the cinch cam has a cinch surface. The latch link has first and second latch surfaces spaced apart along a proximal side spaced between the first and second axes of rotation and a latch groove in a distal side oriented away from the first and second axes of rotation. The latch link is rotatable between a latched condition for engagement with the striker and an unlatched condition for disengagement with the striker. The cinch surface in engaged with the first latch surface in the latched condition and the first and second cam surfaces engage with the first and second latch surfaces, respectively, when the latch link in in the latched condition and deformed under load to prevent inadvertent release from the latched condition to the unlatched condition.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a vehicle seat assembly including a seat back coupled to a seat cushion and having a latch assembly for selectively engaging with and disengaging from a striker attached to the vehicle;

FIG. 2 is a fragmentary side view of a cushion frame of the seat cushion of the vehicle seat assembly including spaced apart cushion frame side members and a latch assembly secured to each cushion frame side member with the seat assembly shown in a use position and an easy entry position;

FIG. 3 is a fragmentary perspective view of a first side of the latch assembly, where the latch assembly is secured to one of the cushion frame side members with a pair of fasteners and illustrating the latch assembly engaged with the striker;

FIG. 4 is a fragmentary exploded perspective view of one of the cushion frame side members including a pair of clinch studs, the latch assembly, and the pair of fasteners;

FIG. 5 is a fragmentary cross-sectional front view taken along line 5-5 of FIG. 3, including a housing bracket, a latch link, a hollow rivet, an extension spring, and a strength cam pin;

FIG. 6 is a fragmentary perspective view of an opposite second side of the latch assembly;

FIG. 7 is a cross-sectional front view of one of the hollow rivets;

FIG. 8 is an exploded perspective view of the latch assembly;

FIG. 9 is a side view of the latch assembly operatively attached to a cable assembly and engaged with the striker in the latched condition; and

FIGS. 10-14 are side views of operation of the latch assembly at operational stages between the latched and unlatched conditions.

### DETAILED DESCRIPTION OF THE EMBODIMENTS

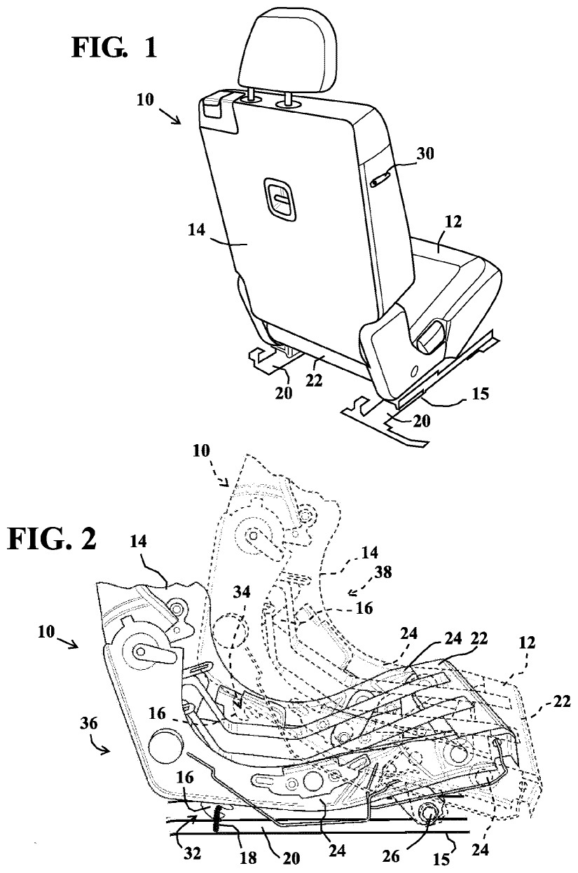

Referring to the Figures, wherein like numerals indicate like or corresponding parts throughout the several views, a seat assembly for use in an automotive vehicle is generally shown at 10 in FIG. 1. The seat assembly 10 includes a generally horizontal seat cushion 12 operatively coupled to a generally upright seat back 14. Referring to FIGS. 1 and 2, the seat cushion 12 typically includes a seat cushion frame 22 for supporting a cellular foam pad encased in a trim cover and the seat back 14 typically includes a seat back frame for supporting a cellular foam pad encased in a trim cover, as is commonly known to one skilled in the art.

The seat assembly 10 is adapted to be releasably coupled to strikers 18 attached to fixed locations on a floor 15 of the automotive vehicle. The seat assembly 10 is pivotally coupled to the floor 15 of the vehicle at fixed pivots 26. As such, when the seat assembly 10 is released from the strikers 18, the seat assembly 10 pivots relative to the floor 15 about the fixed pivots 26 from a use position, shown at 36 in solid lines in FIG. 2, to a forwardly pivoted and upright easy entry position, shown at 38 in dashed lines in FIG. 2. Optionally, a pair of spaced apart seat tracks 20 are operatively attached to the floor 15 of the vehicle to allow fore/aft adjustment of the seat assembly 10 relative to the floor 15, with the strikers 18 and fixed pivots 26 coupled to the respective seat tracks 20.

A latch assembly 16 is provided for releasably securing the seat assembly 10 to the strikers 18 on the floor 15 of the automotive vehicle. More specifically, a latch assembly 16 is operatively coupled to each one of a pair of spaced apart cushion frame side members 24 of the seat cushion frame 22 proximate the rear of the seat cushion 12 to selectively engage with, and disengage from, the strikers 18 via the latch assembly 16. The seat cushion frame 22 is also adapted to be pivotally connected to the floor 15 of the vehicle at the fixed pivots 26 proximate the front of the seat cushion 12.

A release cable 28 extends between a release handle 30 and the latch assemblies 16 for actuating each latch assembly 16 between a latched condition 32 and an unlatched condition 34 to allow the seat assembly 10 to pivot about the fixed pivots 26 between the use position 36 (i.e., seating position) and the easy entry position 38 (i.e., pitched forward position) as will be described in further detail hereinbelow.

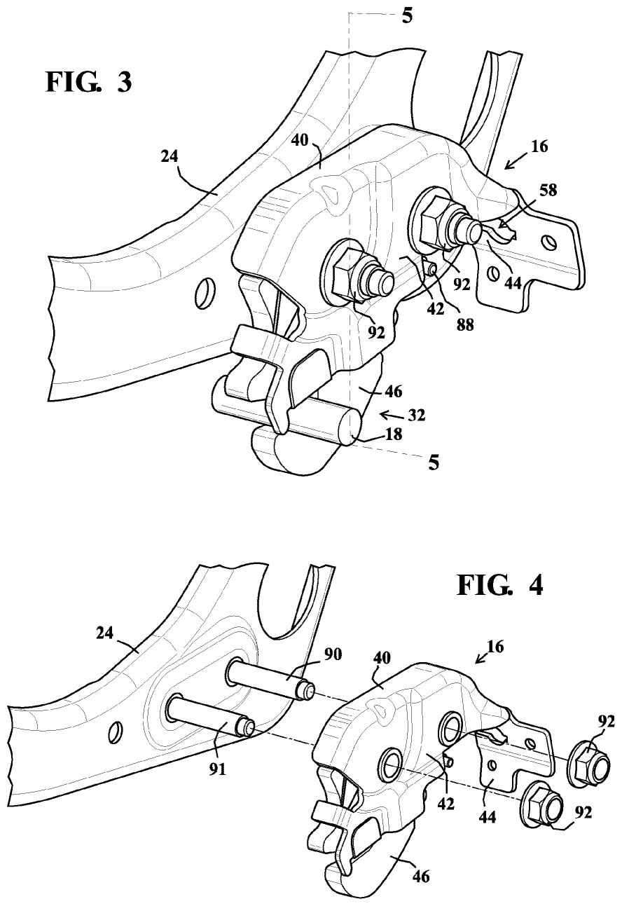

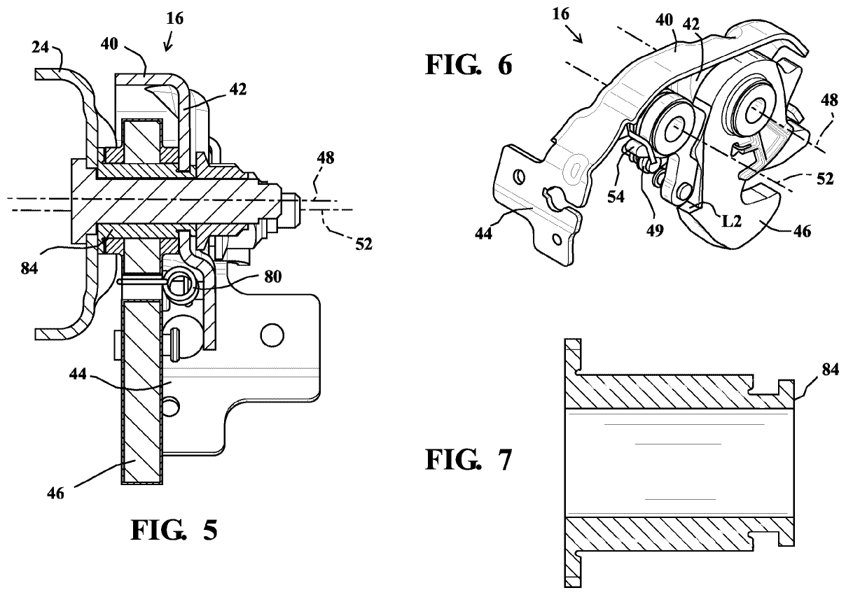

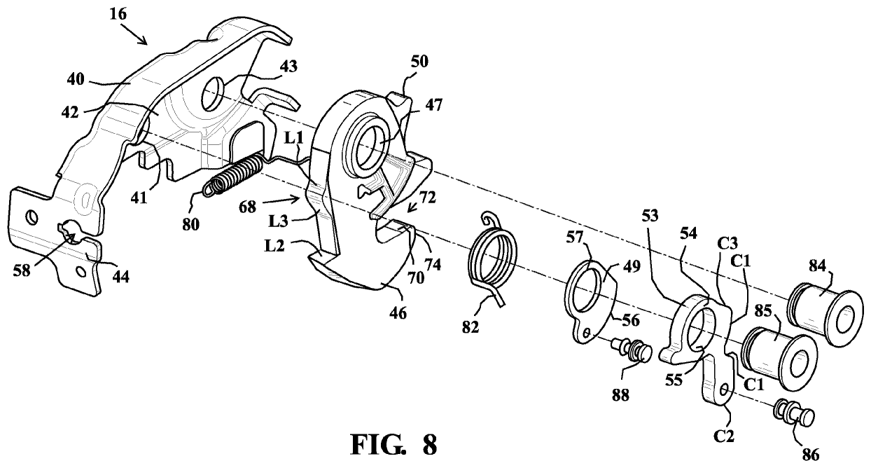

Referring to FIGS. 3-8, each latch assembly 16 includes a housing bracket 40 having a planar housing wall 42 and an attachment segment 44 extending outwardly relative to the housing wall 42. The housing bracket 40 includes a pair of spaced apart mounting holes 41, 43, shown in FIG. 8, extending through the housing wall 42 for receiving a corresponding pair of mounting studs 90, 91 therethough projecting outwardly from each cushion frame side member 24 for mounting the latch assembly 16 to the seat cushion frame 22, as shown in FIG. 4. A pair of flange nuts 92 threadingly engage the distal ends of the mounting studs 90, 91 to attach and secure the latch assembly 16 to seat cushion frame 22, as shown in FIG. 3.

The latch assembly 16 further includes a latch link 46 pivotally connected to the housing bracket 40 by a first cylindrical and hollow rivet 84 and is pivotable about a first axis of rotation 48 for latched engagement with the striker 18. The latch link 46 includes a pivot hole 47 in axial alignment with the first axis of rotation 48 for receiving the first hollow rivet 84 and for receiving and pivotally coupling the latch link 46 to one of the mounting studs 91. A strength cam 54 is pivotally connected to the housing bracket 40 and pivotable about a second axis of rotation 52 for selective engagement with the latch link 46. The first axis of rotation 48 and the second axis of rotation 52 are in a spaced apart and parallel relationship to one another. The strength cam 54 includes a first cam surface C1, a second cam surface C2, and a third cam surface C3 that are circumferentially spaced from one another along an outer peripheral cam wall 53.

A cinch cam 49 is pivotally connected to the housing bracket 40 and pivotable about the second axis of rotation 52 and pivotable relative to the strength cam 54. The cinch cam 49 includes an outer arcuate cinch surface 56. The strength cam 54 includes a pivot hole 55 and the cinch cam 49 includes a pivot hole 57, each in axial alignment with the second axis of rotation 52, for receiving a second hollow rivet 85 therethrough and for receiving and pivotally coupling the strength cam 54 and cinch cam 49 to the other one of the mounting studs 90. A strength cam pin 86 and cinch cam pin 88 are fixedly coupled and project laterally from the strength cam 54 and cinch cam 49, respectively.

A strength cam spring 82 is operatively coupled between the strength cam 54 and the housing bracket 40 for biasing the strength cam 54 into engagement with the latch link 46. An extension spring 80 is operatively coupled between the cinch cam 49 and the latch link 46 for biasing the cinch cam 49 into engagement with the latch link 46.

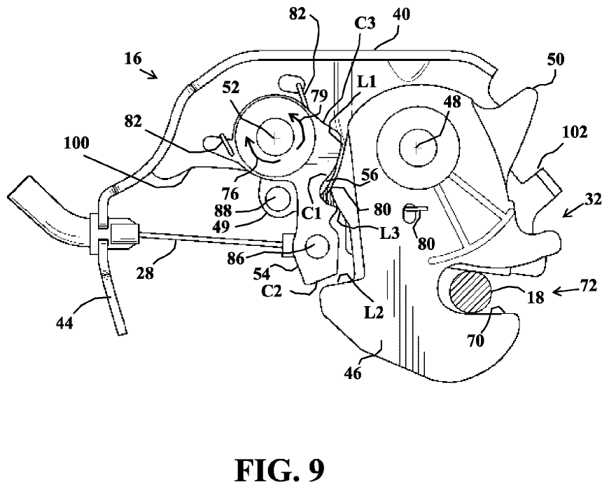

Referring to FIGS. 8 and 9, the attachment segment 44 of housing bracket 40 defines a slot 58 on a cable load axis 60 that extends in generally perpendicular relationship to each one of the first axis of rotation 48 and the second axis of rotation 52. The release cable 28 passes through the slot 58 in the attachment segment 44 of the housing bracket 40 and is fixedly coupled to the strength cam pin 86 for actuating the latch assembly 16 between the latched and unlatched conditions 32, 34.

The latch link 46 further includes a first latch surface L1, a second latch surface L2, and a third latch surfaces L3 circumferentially spaced from one another along a proximal side 68 of the latch link 46, relative to the first axis of rotation 48, and seated between the first and second axes of rotation 48, 52. The third latch surface L3 is circumferentially disposed relative to the first axis of rotation 48 between the first latch surface L1 and the second latch surface L2. The latch link 46 further includes a latch groove 70 defining a groove inlet 72 in an opposite distal side 74 of the latch link 46 that is oriented away from the first and second axes of rotation 48, 52, and facing opposite the attachment segment 44 of housing bracket 40 for receiving the striker 18 therein.

With reference to FIG. 9, the cinch surface 56 of the cinch cam 49 engages with first cam surface L1 on the latch link 46 to retain the latch link 46 in the latched condition 32 with the striker 18. The first and second cam surfaces C1, C2 of the strength cam 54 are circumferentially spaced apart from one another and configured to engage with the respective first and second latch surfaces L1, L2 on the latch link 46 when the latch link 46 is engaged with the striker 18 and the latch link 46 is deformed under load to prevent the latch link 46 from inadvertently releasing or unlatching with the striker 18 in the latched condition 32. That is, both the cinch cam 49 and the strength cam 54 engage the latch link 46 to retain the latch link 46 engaged with the striker 18 in the latched condition 32 and the cam surfaces C1, C2 engage with the latch surfaces L1, L2 during deformation loading of the latch assembly 16 to prevent inadvertent release of the latch assembly 16 with the striker 18. Further, the third cam surface C3 on the strength cam 54 engages with the third latch surface L3 on the latch link 46 to retain the latch link 46 in the unlatched condition 34 (i.e., hold-open condition), as will be further described below.

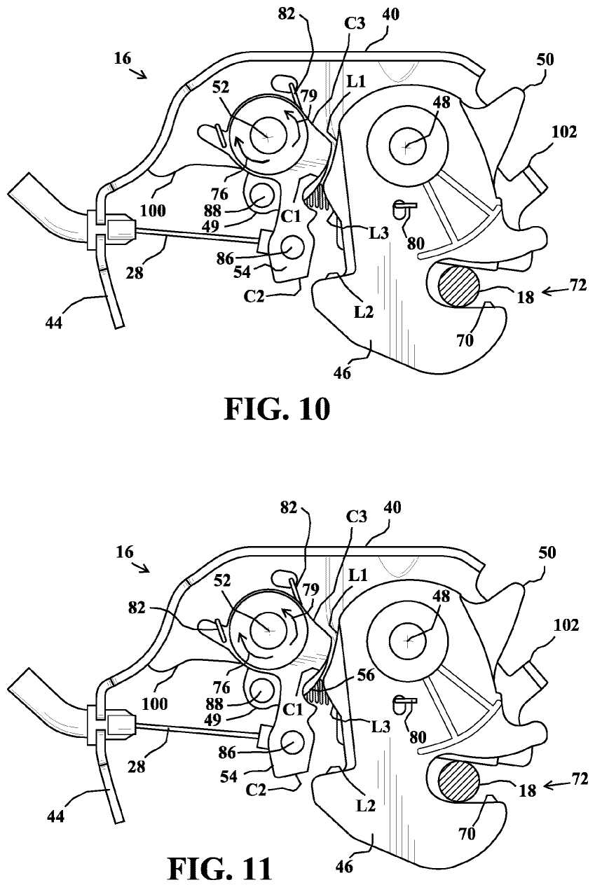

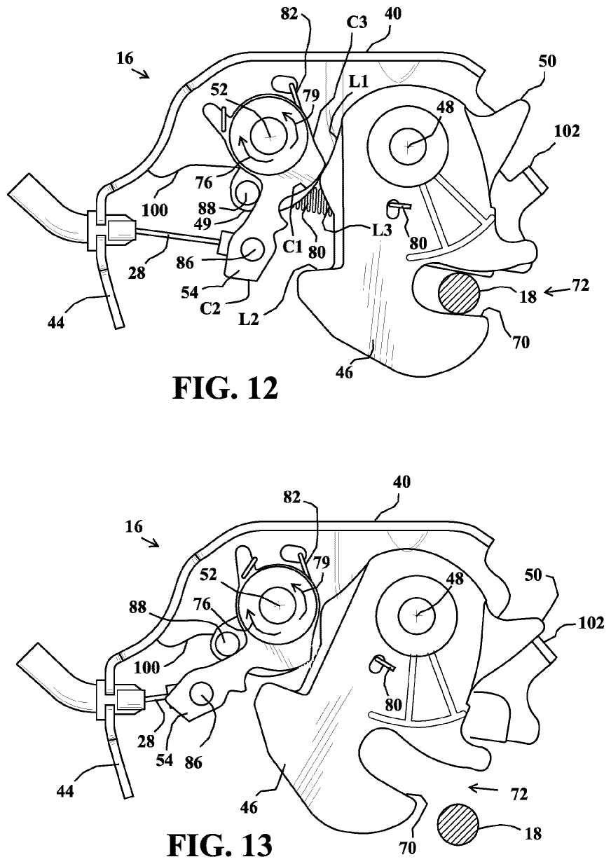

Referring now to FIGS. 10-14, in operation, actuation of the release handle 30 pulls the release cable 28 to rotate the strength cam 54 in a first rotary direction 76 about the second axis of rotation 52 (clockwise in the FIGS.). The strength cam 54 contacts the cinch cam pin 88 to concurrently rotate the cinch cam 49 in the first rotary direction 76 and disengage the cinch surface 56 of the cinch cam 49 from engagement with the latch surface L1 on the latch link 46, as shown in FIGS. 10 and 11. Continued rotation of the strength cam 54 and cinch cam 49 forces the extension spring 80 to pull and rotate the latch link 46 in the first rotary direction (clockwise in the FIGS.) and allows the latch link 46 to rotate to the end of the cinch cam surface 56, as shown in FIG. 12. The strength cam 54 and cinch cam 46 continue to rotate until the cinch cam pin 88 engages a first hard stop 100 on the housing bracket 40 and the latch link 46 is fully released from engagement with the striker 18, as shown in FIG. 13. As tension is removed on the release cable 28, the strength cam 54 rotates slightly in the reverse, opposite, second rotary direction 79 (counterclockwise in the FIGS.) until the cam surface C3 contacts the latch surface L3 to maintain the latch assembly 16 in the unlatched condition 34 (i.e., hold-open condition This allows the seat assembly 10 to rotate from the use position 36 to the easy entry position 38. Additionally, in the unlatched condition 34, a front projection 50 on the latch link 46 engages a second hard stop 102 on the housing bracket 40 to prevent over-rotation of the latch link 46.

In order to return the latch assembly 16 to the latched condition 32, the seat assembly 10 is rotated about the fixed pivots 26 from the easy entry position 28 back toward the use position 36. During this rotation, the striker 18 contacts the groove inlet 72 of the latch link 46. Further rotation of the seat assembly 10 causes the latch link 46 to rotate in the second rotary direction 79 (counterclockwise in the FIGS.). As the latch link 46 rotates in the second rotary direction 79, the latch surface L3 slides against the cam surface C3. Once the latch surface L3 bypasses the cam surface C3, the strength cam spring 82 rotates the strength cam 54 in the second rotary direction 79. As the strength cam 54 rotates in the second rotary direction 79, the extension spring 80 also rotates the cinch cam 49 in the second rotary direction 79. The cinch cam surface 56 reengages with the latch surface L1, and the strength cam 54 and latch link 46 are returned to the latched condition 32. The striker 18 is recaptured in the latch groove 70 of the latch link 46, and the latch assembly 16 is returned to the latched condition 32.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A latch assembly adapted for releasably securing a seat assembly to a striker in an automotive vehicle, the latch assembly comprising:
a housing bracket;
a latch link pivotally coupled to the housing bracket about a first axis of rotation, the latch link having first and second latch surfaces spaced apart along a proximal side and having a latch groove in a distal side oriented away from the first axis of rotation;
a cinch cam and a strength cam pivotally coupled to the housing bracket about a second axis of rotation spaced apart from the first axis of rotation, the strength cam having first and second cam surfaces spaced apart along an outer edge spaced between the first and second axes of rotation and the cinch cam having a cinch surface;
wherein the latch link is rotatable between a latched condition for engagement with the striker and an unlatched condition for disengagement with the striker;
wherein the cinch surface in engaged with the first latch surface in the latched condition and the first and second cam surfaces engage with the first and second latch surfaces, respectively, when the latch link in in the latched condition and deformed under load to prevent inadvertent release from the latched condition to the unlatched condition.

2. The latch assembly as set forth in claim 1 wherein the latch link includes a third latch surface and the strength cam includes a third cam surface, wherein the third cam surface engages with the third latch surface in the unlatched condition to hold open the latch link from engagement with the striker.

3. The latch assembly as set forth in claim 2 further including a first hollow rivet pivotally coupling the latch link to the housing bracket about the first axis of rotation.

4. The latch assembly as set forth in claim 3 further including a second hollow rivet pivotally coupling the strength cam and cinch cam to the housing bracket about the second axis of rotation.

5. The latch assembly as set forth in claim 4 further including a strength cam spring operatively coupled between the strength cam and the housing bracket for biasing the strength cam into engagement with the latch link.

6. The latch assembly as set forth in claim 5 further including an extension spring operatively coupled between the cinch cam and the latch link for biasing the cinch cam into engagement with the latch link.

7. The latch assembly as set forth in claim 6 further including a strength cam pin fixedly projecting from the strength cam and a release cable coupled to the strength cam pin for actuating the strength cam in a first rotary direction about the second axis of rotation.

8. The latch assembly as set forth in claim 7 further including a cinch cam pin fixedly projecting from the cinch cam for engagement with the strength cam in response to rotation of the strength cam in the first rotary direction to release the latch link from the latched condition to the unlatched condition.

9. The latch assembly as set forth in claim 8 wherein the housing bracket includes a first hard stop for engaging the cinch cam pin upon rotation in the first rotary direction when the latch link in in the unlatched condition.

10. The latch assembly as set forth in claim 9 wherein the housing bracket includes a second hard stop for engaging with a front projection on the latch link to prevent the latch link from over-rotating in the unlatched condition.

11. The latch assembly as set forth in claim 10 wherein the housing bracket includes a first mounting hole adapted for receiving a mounting stud on the seat assembly for rotatably supporting the second hollow rivet, cinch cam and strength cam.

12. The latch assembly as set forth in claim 11 wherein the housing bracket includes a second mounting hole adapted for receiving a second mounting stud for rotatably supporting the first hollow rivet and latch link.

13. The latch assembly as set forth in claim 12 further including flange nuts adapted to be coupled to each of the first and second mounting studs for mounting the latch assembly to the seat assembly.

14. The latch assembly as set forth in claim 13 further including a release handle coupled to the release cable for actuating the latch assembly between the latched and unlatched conditions.
